(19) United States
(12) Patent Application Publication
(10) Pub. No.: US 2025/0390790 A1
(43) Pub. Date: Dec. 25, 2025

(54) SYSTEM AND METHOD FOR ITERATIVE AND HIERARCHICAL QUANTITATIVE DIAGNOSTICS AND DETECTION OF SYNTHETIC MEDIA DATA

(71) Applicant: BANK OF AMERICA CORPORATION, Charlotte, NC (US)

(72) Inventors: Anisa Bansal, Hyderabad (IN); Gowthaman Sundararaj, Chennai (IN); Vijay Kumar Yarabolu, Hyderabad (IN)

(73) Assignee: BANK OF AMERICA CORPORATION, Charlotte, NC (US)

(21) Appl. No.: 18/753,560

(22) Filed: Jun. 25, 2024

(51) Int. Cl. G06N 20/00

(52) U.S. Cl. CPC G06N 20/00

(57) ABSTRACT

Systems, computer program products, and methods are described herein for iterative and hierarchical quantitative diagnostics and detection of synthetic media data. The present disclosure includes receiving an interaction, collecting a plurality of identity feature vectors from the media data, determining a vector similarity score for each identity feature vector by comparing, using a trained machine learning model, to stored identity feature vectors, determining a confidence score, determining a trust score, determining a cumulative trust score for each respective time interval, determining a temporal cumulative trust score comprising the cumulative trust score for each respective time interval, terminating the interaction the temporal cumulative trust score is below a third predetermined threshold, and transmitting a control signal to an endpoint device upon occurrence of the second condition.

### TECHNOLOGICAL FIELD

Example implementations of the present disclosure relate to a system and method for iterative and hierarchical quantitative diagnostics and detection of synthetic media data.

### BACKGROUND

The prevalence of deepfakes, generated using sophisticated artificial intelligence techniques and algorithms, poses a significant challenge. These deepfakes are highly realistic, making it difficult to distinguish them from genuine content. The advanced methods used in their creation enable the mimicry of actual users with alarming accuracy. As a result, identifying and detecting these malfeasant representations is exceptionally tough, complicating efforts to counteract the deception they facilitate. This disclosure addresses the critical need for effective deepfake detection mechanisms.

### BRIEF SUMMARY

Systems, methods, and computer program products are provided for iterative and hierarchical quantitative diagnostics and detection of synthetic media data.

In one aspect, a system for iterative and hierarchical quantitative diagnostics and detection of synthetic media data is presented. The system includes a processing device, a non-transitory storage device containing instructions when executed by the processing device, causes the processing device to perform the steps of receiving an interaction comprising media data, collecting, at a predetermined time interval over a duration of the interaction, a plurality of identity feature vectors from the media data, each identity feature vector of the plurality of identity feature vectors being associated with an identity attribute of a plurality of identity attributes, determining a vector similarity score for each identity feature vector of the plurality of identity feature vectors by comparing, using a trained machine learning model, each identity feature vector of the plurality of identity feature vectors to stored identity feature vectors, determining, for each identity attribute for the predetermined time intervals, a confidence score for each vector similarity score may have a value above a first predetermined threshold, determining a trust score for each vector similarity score may have a confidence score, wherein the trust score is equally weighted with other respective vector similarity score may have a confidence score above a second predetermined threshold within a respective time interval, wherein the trust score is zero upon a first condition where the confidence score is below the second predetermined threshold, and wherein the trust scores for the identity attribute over the duration of the interaction forms a trust score series associated with the identity attribute, determining a cumulative trust score for each respective time interval, determining a temporal cumulative trust score comprising the cumulative trust score for each respective time interval, terminating the interaction upon a second condition where the temporal cumulative trust score is below a third predetermined threshold, and transmitting a control signal to an endpoint device upon occurrence of the second condition.

In some implementations, the instructions may further cause the processing device to perform the steps of receiving a training interaction comprising training media data, labeling the training media data to form labeled training media data, training a machine learning model using the labeled training media data to form the trained machine learning model, and hyperparameter tuning of the trained machine learning model.

In some implementations, the instructions may further cause the processing device to perform the steps of determining a training flag value for further training of the trained machine learning model by comparing each confidence score to a predetermined confidence score threshold.

In some implementations, collecting the plurality of identity feature vectors from the media data occurs in real-time.

In some implementations, each identity attribute of the plurality of identity attributes is selected from the group consisting of facial data, eye movement data, voice data, iris data, facial expression data, gesture data, passive liveness data, and skin texture.

In some implementations, each identity feature vector of the plurality of identity feature vectors is selected from the group consisting of an identity attribute vector and a feature vector.

In some implementations, the instructions may further cause the processing device to perform the steps of determining a feature validation score for each identity attribute based on trust scores within the trust score series associated with the identity attribute, and terminating the interaction upon a third condition where the feature validation score is below a fourth predetermined threshold.

In another aspect, a computer program product for iterative and hierarchical quantitative diagnostics and detection of synthetic media data is presented. The computer program product includes a non-transitory computer-readable medium including code causing an apparatus to receive an interaction comprising media data, collect, at a predetermined time interval over a duration of the interaction, a plurality of identity feature vectors from the media data, each identity feature vector of the plurality of identity feature vectors being associated with an identity attribute of a plurality of identity attributes, determine a vector similarity score for each identity feature vector of the plurality of identity feature vectors by comparing, using a trained machine learning model, each identity feature vector of the plurality of identity feature vectors to stored identity feature vectors, determine, for each identity attribute for the predetermined time intervals, a confidence score for each vector similarity score may have a value above a first predetermined threshold, determine a trust score for each vector similarity score may have a confidence score, wherein the trust score is equally weighted with other respective vector similarity score may have a confidence score above a second predetermined threshold within a respective time interval, wherein the trust score is zero upon a first condition where the confidence score is below the second predetermined threshold, and wherein the trust scores for the identity attribute over the duration of the interaction forms a trust score series associated with the identity attribute, determine a cumulative trust score for each respective time interval, determine a temporal cumulative trust score comprising the cumulative trust score for each respective time interval, terminate the interaction upon a second condition where the temporal cumulative trust score is below a third predetermined threshold, and transmit a control signal to an endpoint device upon occurrence of the second condition.

In some implementations, the code may further cause the apparatus to receive a training interaction comprising training media data, label the training media data to form labeled training media data, train a machine learning model using the labeled training media data to form the trained machine learning model, and hyperparameter tune of the trained machine learning model.

In some implementations, the code may further cause the apparatus to determine a training flag value for further training of the trained machine learning model by comparing each confidence score to a predetermined confidence score threshold.

In some implementations, collecting the plurality of identity feature vectors from the media data occurs in real-time.

In some implementations, each identity attribute of the plurality of identity attributes is selected from the group consisting of facial data, eye movement data, voice data, iris data, facial expression data, gesture data, passive liveness data, and skin texture.

In some implementations, each identity feature vector of the plurality of identity feature vectors is selected from the group consisting of an identity attribute vector and a feature vector.

In some implementations, the code may further cause the apparatus to determine a feature validation score for each identity attribute based on trust scores within the trust score series associated with the identity attribute, and terminate the interaction upon a third condition where the feature validation score is below a fourth predetermined threshold.

In yet another aspect, a method for iterative and hierarchical quantitative diagnostics and detection of synthetic media data is presented. The method may include receiving an interaction comprising media data, collecting, at a predetermined time interval over a duration of the interaction, a plurality of identity feature vectors from the media data, each identity feature vector of the plurality of identity feature vectors being associated with an identity attribute of a plurality of identity attributes, determining a vector similarity score for each identity feature vector of the plurality of identity feature vectors by comparing, using a trained machine learning model, each identity feature vector of the plurality of identity feature vectors to stored identity feature vectors, determining, for each identity attribute for the predetermined time intervals, a confidence score for each vector similarity score may have a value above a first predetermined threshold, determining a trust score for each vector similarity score may have a confidence score, wherein the trust score is equally weighted with other respective vector similarity score may have a confidence score above a second predetermined threshold within a respective time interval, wherein the trust score is zero upon a first condition where the confidence score is below the second predetermined threshold, and wherein the trust scores for the identity attribute over the duration of the interaction forms a trust score series associated with the identity attribute, determining a cumulative trust score for each respective time interval, determining a temporal cumulative trust score comprising the cumulative trust score for each respective time interval, terminating the interaction upon a second condition where the temporal cumulative trust score is below a third predetermined threshold, and transmitting a control signal to an endpoint device upon occurrence of the second condition.

In some implementations, the method may further include receiving a training interaction comprising training media data, labeling the training media data to form labeled training media data, training a machine learning model using the labeled training media data to form the trained machine learning model, and hyperparameter tuning of the trained machine learning model.

In some implementations, the method may further include determining a training flag value for further training of the trained machine learning model by comparing each confidence score to a predetermined confidence score threshold.

In some implementations, collecting the plurality of identity feature vectors from the media data occurs in real-time.

In some implementations, each identity attribute of the plurality of identity attributes is selected from the group consisting of facial data, eye movement data, voice data, iris data, facial expression data, gesture data, passive liveness data, and skin texture.

In some implementations, each identity feature vector of the plurality of identity feature vectors is selected from the group consisting of an identity attribute vector and a feature vector.

In some implementations, the method may further include determining a feature validation score for each identity attribute based on trust scores within the trust score series associated with the identity attribute, and terminating the interaction upon a third condition where the feature validation score is below a fourth predetermined threshold.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for iterative and hierarchical quantitative diagnostics and detection of synthetic media data, in accordance with an implementation of the disclosure;

FIG. 2 illustrates a graphical architectural representation of iterative and hierarchical quantitative diagnostics and detection of synthetic media data, in accordance with an implementation of the disclosure;

FIG. 3 illustrates an exemplary machine learning model subsystem architecture, in accordance with an implementation of the disclosure;

FIG. 4 illustrates a process flow for iterative and hierarchical quantitative diagnostics and detection of synthetic media data, in accordance with an implementation of the disclosure; and

FIGS. 5A-5B illustrate a tabular representation of iterative and hierarchical quantitative diagnostics and detection of synthetic media data, in accordance with an implementation of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “synthetic media” or “synthetic media data” may refer to video, audio, or the like that has been generated artificially using techniques such as machine learning and artificial intelligence. This can include content that appears entirely realistic, even though it does not depict a real event or person.

As used herein, “identity attribute” may refer to any unique characteristic or piece of data that can be used to identify an individual. This can include inherent traits such as physical descriptions (eye color, height), or behavioral characteristics (voice patterns, signature). It can also encompass user-assigned details like usernames, passwords, or PINs. Additionally, or alternatively, identity attributes may be derived from actions or interactions, such as login locations, IP addresses, or browsing history.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, user characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some implementations, the system may be owned or operated by an entity. In such implementations, the entity may employ additional computer systems, such as authentication servers, to validate and certify resources inputted by the plurality of users within the system. The system may further use its authentication servers to certify the identity of users of the system, such that other users may verify the identity of the certified users. In some implementations, the entity may certify the identity of the users. Furthermore, authentication information or permission may be assigned to or required from a user, application, computing node, computing cluster, or the like to access stored data within at least a portion of the system.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

The technical problem and challenges lie in the widespread use of deepfakes, fueled by complex AI and algorithms. This presents a substantial technical challenge to entities that rely on authentication and verification of user identity in order to proceed with resource transfers. A malfeasant actor may use technology that is increasingly good at pretending to be someone, and thereafter thwart entity systems. These deepfakes are alarmingly realistic and replicating real peoples' appearances and speech patterns. The very techniques that underlie their creation, allowing for the mimicry of real people with uncanny precision, make them incredibly difficult to identify. Traditional methods of content verification (e.g., detection of deepfakes or “synthetic media”) are rendered nearly useless, which leaves a gap in the ability to mitigate the harm they can cause.

Existing detection methods struggle to keep pace with this rapid advancement, and often fail to identify deepfakes that incorporate the latest AI functionalities. Furthermore, these methods are computationally expensive and resource-intensive, limiting their scalability for widespread deployment.

Addressing these challenges requires the establishment of a system and method for iterative and hierarchical quantitative diagnostics and detection of synthetic media data. Such a framework allows for the collection, analysis, and validation of multiple identity attribute features instead of a singular feature, and to do so in an interactive recurring fashion throughout an interaction having media data. By combining the analyses of multiple identity attribute features and systematically evaluating each identity attribute feature in view of the other identity attribute features, the present disclosure embraces a multifactor style of authentication of media data and improves the accuracy of synthetic media detection.

To do so, an interaction having media data (video, audio, or the like) is received either retroactively, or in real-time, and identity feature vectors are collected from the media data at predetermined time intervals. Using a trained machine learning model, a vector similarity score may be determined for each identity feature vector by comparing the identity feature vector to stored identity feature vectors. A confidence score may then be determined for each identity attribute (gesture, face recognition, iris movement and size, or the like) having a value above a predetermined threshold for each predetermined time interval within the interaction. Then, for each identity attribute for the time intervals, a confidence score is determined if each vector similarity score has a value above a threshold. Next, a trust score may be determined for each vector similarity score that has received a confidence score. This trust score may be weighted equally with others within the same time interval. A cumulative trust score may then be determined for each respective time interval, and a temporal cumulative trust score for all time intervals may be determined. Additionally, or as an alternative to the determination of the temporal cumulative trust score a feature validation score may be determined for each identity attribute, based on the contents of the trust scores throughout the interaction for a particular identity attribute. Additionally, or alternatively, a compiled feature validation score may be determined. The system may then terminate the interaction if (i) the temporal cumulative trust score is below a threshold, (ii) the feature validation score, or (iii) the compiled feature validation score and subsequently transmit a control signal to an endpoint device to alert user(s) of the presence of synthetic media data.

What is more, the present disclosure provides a technical solution to a technical problem. As described herein, the technical problem includes the inability to detect deepfake interaction involving synthetic media due to the ever-changing algorithmic generation models used to do so. The present disclosure embraces an improvement over existing solutions by allowing for the detection of synthetic media data interactions (i) with fewer steps to achieve the solution (e.g., collecting multiple identity attribute features concurrently instead of one at a time), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., detecting synthetic media with a high degree of confidence and reduce false detections), (iii) removing manual input and waste from the implementation of the solution, thus improving speed and efficiency of the process and conserving network resources (e.g., preventing the input of additional credentials by the user to prove their identity, and instead relying on the media data received during the interaction), (iv) determining an optimal amount of resources that need to be used to implement the solution, thus reducing network traffic and load on existing network resources (e.g., ignoring further analysis of identity data that does not meet predetermined thresholds). In other words, the solution may bypass a series of steps previously implemented, thus further conserving network resources. Furthermore, the technical solution described herein uses a rigorous, computerized process to perform specific tasks and/or activities that were not previously performed.

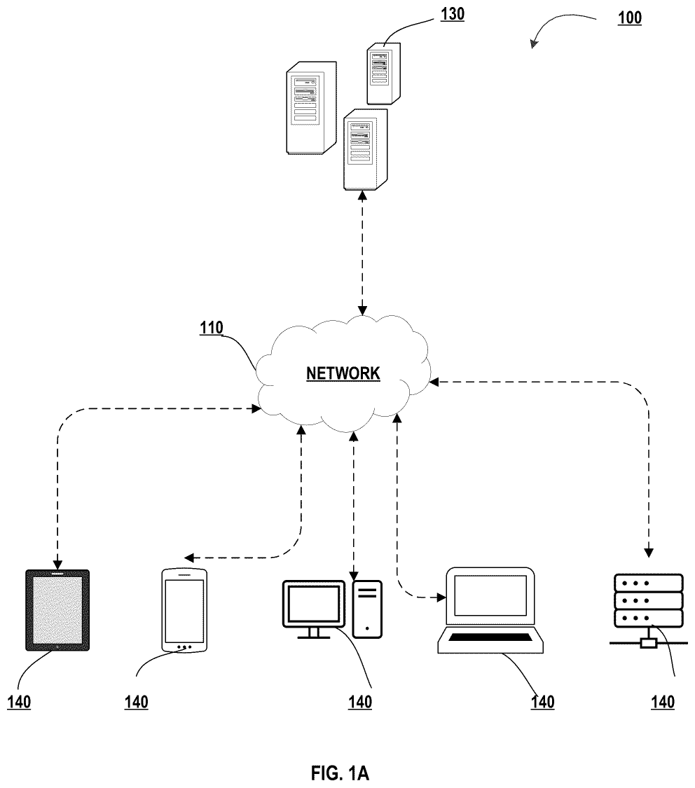

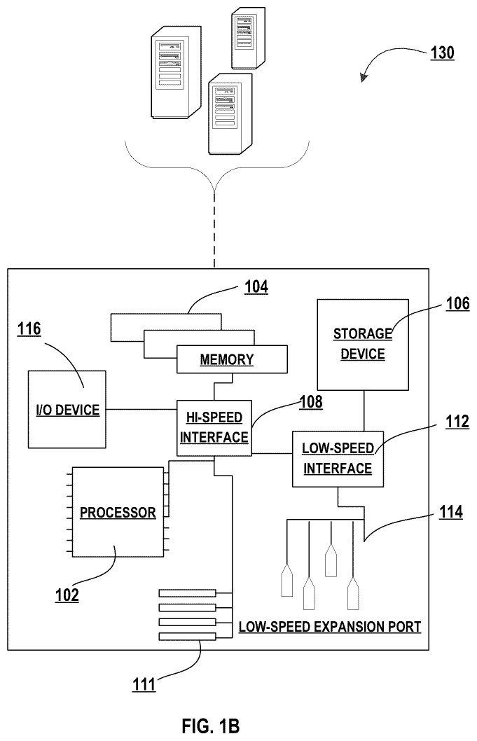

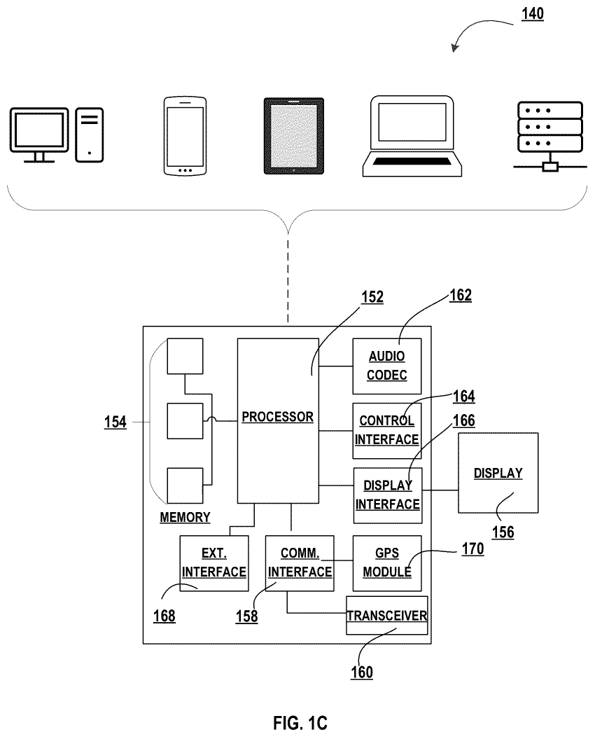

FIGS. 1A-1C illustrate technical components of an exemplary distributed computing environment 100 for iterative and hierarchical quantitative diagnostics and detection of synthetic media data, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive service from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low speed bus 114 and storage device 106. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processor 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the endpoint device(s) 140, including instructions stored in the memory 154, which in one implementation includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the endpoint device(s) 140, such as control of user interfaces, applications run by endpoint device(s) 140, and wireless communication by endpoint device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

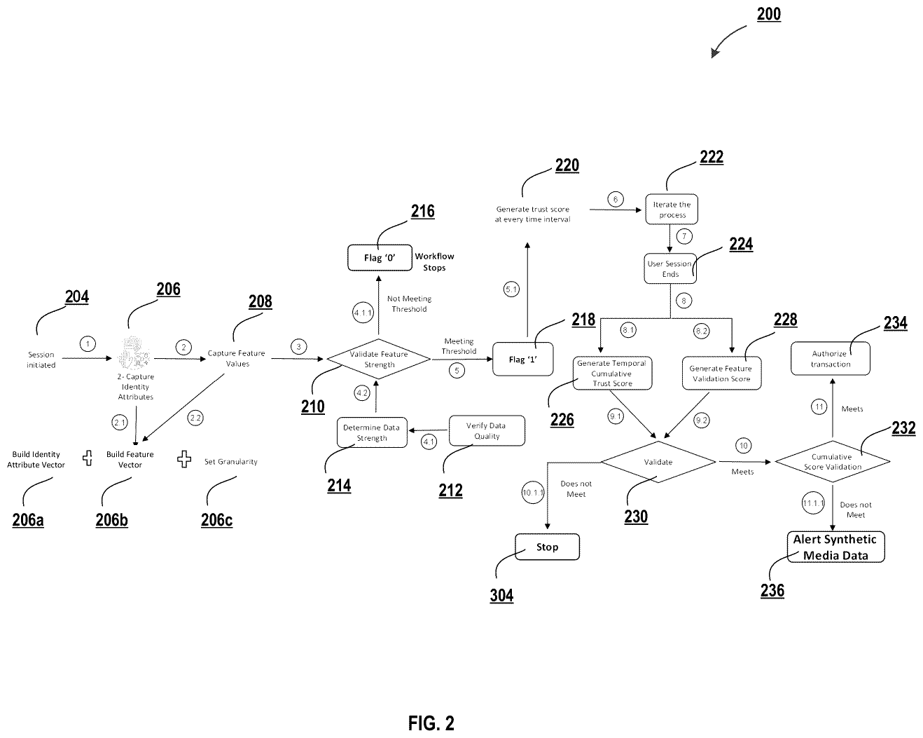

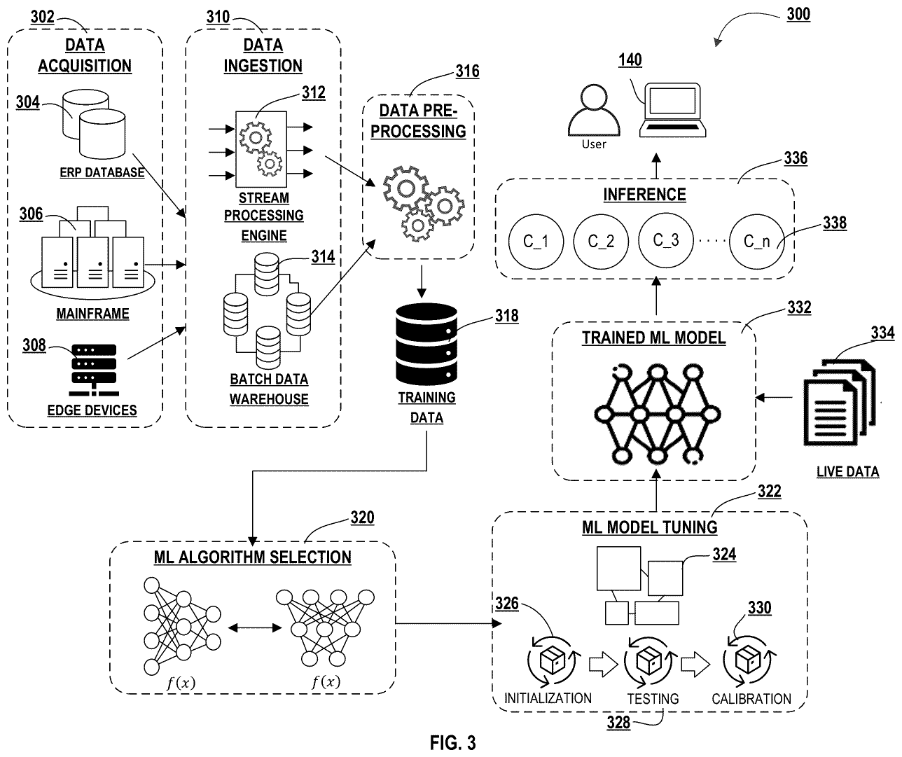

FIG. 2 illustrates a graphical architectural representation of iterative and hierarchical quantitative diagnostics and detection of synthetic media data, in accordance with an implementation of the disclosure. FIG. 2 serves as an overview of the process that will be described in detail herein with respect to FIGS. 3A through 5, and thus shall not be construed as limiting in nature. A session may be initiated at block 204. The “session” may include any execution of the computer code in the system directed to interpret media data, and in particular the interpretation of media data provided as a result of an interaction between an entity (e.g., an endpoint device in the entity network) and a user (or a user endpoint device in the entity network).

As a result of the interaction, various identity attributes are captured in block 206. For example, as is the case with video data, identity attributes that include facial features, eye, iris, and/or retina features, gestures, texture of a person, or the like, may be captured. Additionally, or alternatively, voice data may be captured, such as tone, voice inflection, or other similar attributes. Additionally, or alternatively, fingerprint, handprint, or other features of the user may be captured (i.e., collected).

The system captures feature values in block 208 by building an identity attribute vector 206a and/or feature vector 206b. Additionally, or alternatively, a granularity 206c may be set of the aforementioned vectors. The feature strength may then validated in block 210, which is a result of the verification of data quality, shown in block 212, and the determination data strength, shown in block 214. The feature strength may be compared to a predetermined threshold to determine if the feature strength is appropriate for use in later analyses, where if it is not appropriate, the workflow stops at block 216. A flag may be provided alongside this data such as the numeral “0” or the like.

If, however, the feature strength is above the predetermined threshold, a flag may be provided alongside this data such as the numeral “1” or the like, as indicated in block 218, then the process continues at block 220, where a trust score is generated for every time interval (typically of predetermined time intervals) throughout the receipt of the media data, or for a predetermined amount of time during the receipt of the media data. The process may be iterated, as illustrated in block 222.

After the session ends, as shown in block 224, or in some implementations, during the user session at a predetermined instance, the process may continue to further validate the media data. At block 226, the temporal cumulative trust score may be generated. At block 228, the feature validation score may be generated. In some implementations, if both the temporal cumulative trust score and the feature validation score meet respective predetermined thresholds, the media data is validated at block 230 and the process may continue. In some implementations, if only one of either the temporal cumulative trust score or the feature validation score meets its respective predetermined threshold, the media data may be validated at block 230 and the process may continue. Otherwise (e.g., if either both the temporal cumulative trust score and the feature validation score do not meet their respective predetermined thresholds, or in other embodiments, if either the temporal cumulative trust score or the feature validation score do not meet their respective predetermined threshold), the process may stop at block 304.

If validated at block 230, the process may continue and a cumulative score may be determined and validated against a predetermined threshold at block 232. If it meets the threshold, the transaction may be authorized at block 234. Otherwise, if it does not meet this threshold, the system may alert the user or the entity (or an endpoint device) of the synthetic media data at block 236.

As will be discussed in detail herein, a machine learning model may be implemented to determine the vector similarity score for identity feature vectors. As such, FIG. 3 illustrates an exemplary machine learning model subsystem architecture 300, in accordance with an implementation of the disclosure.

The machine learning subsystem 300 may include a data acquisition engine 302, data ingestion engine 310, data pre-processing engine 316, machine learning model tuning engine 322, and inference engine 336.

The data acquisition engine 302 may identify various internal and/or external data sources to generate, test, and/or integrate new features for training the machine learning model 324. These internal and/or external data sources 304, 306, and 308 may be initial locations where the data originates or where physical information is first digitized. The data acquisition engine 302 may identify the location of the data and describe connection characteristics for access and retrieval of data. In some implementations, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some implementations, the these data sources 304, 306, and 308 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In machine learning, the quality of data and the useful information that can be derived therefrom directly affects the ability of the machine learning model 324 to learn. The data pre-processing engine 316 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 318 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 318 may additionally, or alternatively, be provided from a third party, having been generated as synthetic data.

The machine learning model tuning engine 322 may be used to train a machine learning model to form a trained machine learning model 324 using the training data 318 to make predictions or decisions without explicitly being programmed to do so. The machine learning model 324 represents what was learned by the selected machine learning algorithm 320 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 322 may repeatedly execute cycles of experimentation 326, testing 328, and tuning 330 to optimize the performance of the machine learning algorithm 320 and refine the results in preparation for deployment of those results for consumption or decision making. To this end, the machine learning model tuning engine 322 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained machine learning model 332 is one whose hyperparameters are tuned and model accuracy maximized.

The trained machine learning model 332, similar to any other software application output, can be persisted to storage, file, memory, or application, or looped back into the processing component to be reprocessed. More often, the trained machine learning model 332 is deployed into an existing production environment to make practical business decisions based on live data 334. To this end, the machine learning subsystem 300 uses the inference engine 336 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 338) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 338) live data 334 based on how similar they are to one another to solve exploratory challenges where little is known about the data, provide a description or label (e.g., C_1, C_2 . . . C_n 338) to live data 334, such as in classification, and/or the like. These categorized outputs, groups (clusters), or labels are then presented to the user input system 130. In still other cases, machine learning models that perform regression techniques may use live data 334 to predict or forecast continuous outcomes.

It shall be understood that the implementation of the machine learning subsystem 300 illustrated in FIG. 3 is exemplary and that other implementations may vary. As another example, in some implementations, the machine learning subsystem 300 may include more, fewer, or different components.

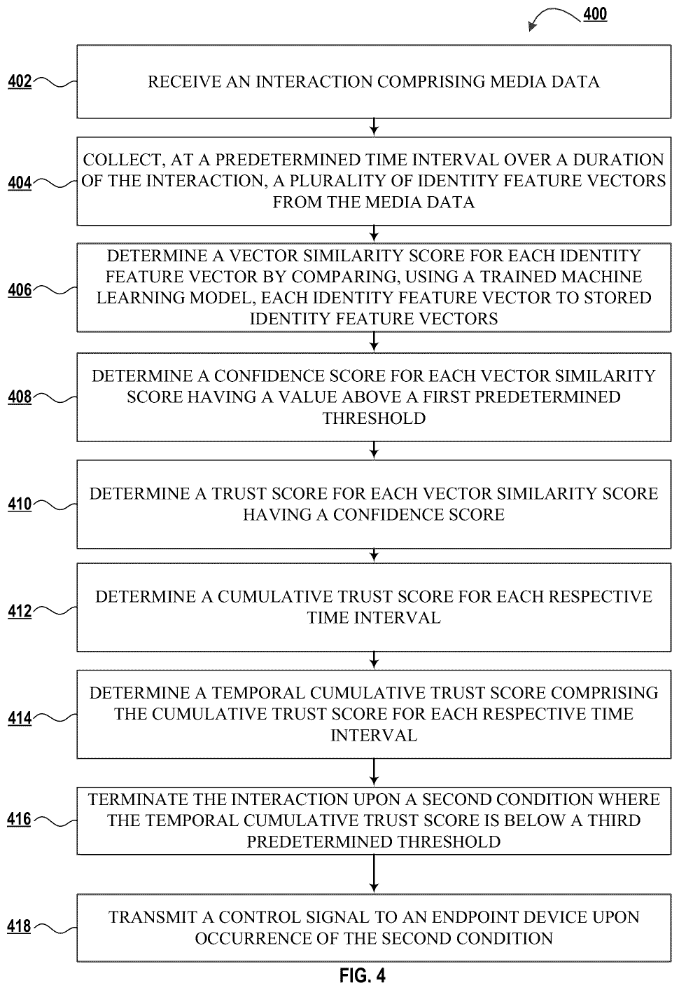

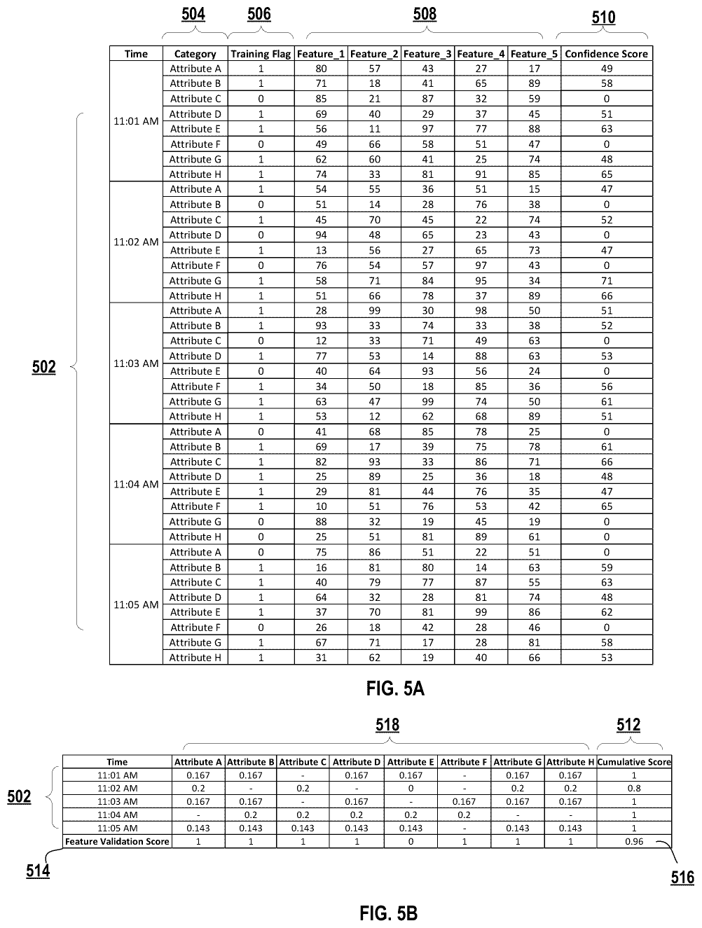

FIG. 4 illustrates a process flow for iterative and hierarchical quantitative diagnostics and detection of synthetic media data, in accordance with an implementation of the disclosure. Reference may also be made hereinafter to FIGS. 5A-5B, which illustrate a tabular representation of iterative and hierarchical quantitative diagnostics and detection of synthetic media data, in accordance with an implementation of the disclosure.

The process may begin at block 402 where the system 130 receives an interaction comprising media data. Media data may include various forms of digital content, including video, audio, images, and text. When the system 130 receives an interaction involving media data, it may processes the video streams, audio files, or other multimedia formats, as is described herein. The system 130 may also decode and manage the incoming media data to proper handling and storage, while maintaining data integrity.

As previously defined, an “interaction” can include numerous activities that result in communication between a user and an entity, often (but not always) through an endpoint device 140. For example, a user may engage with a video streaming service by initiating a video chat session, providing media data in the form of a live video stream. As the user's device (i.e., endpoint device 140) captures the video stream, it encodes the visual and audio components into a digital format suitable for transmission over the network. Once received by the system 130, the process may continue as described hereinafter.

At block 404, the system 130 may collect, at a predetermined time interval over a duration of the interaction, a plurality of identity feature vectors from the media data. In some implementations, the identity feature vectors from the media data may occur in real-time, such as during the interaction, by analyzing the media data as it becomes available. In other implementations, the system 130 may process media data previously stored from interactions that occurred at an earlier time.

The system 130 receives the media data and may processes it to extract identity feature vectors. These identity feature vectors correspond to various physical attributes (i.e., “identity attributes”) such as shape, color, texture, and motion (and represented by facial data, eye movement data, voice data, iris data, facial expression data, gesture data, passive liveness data, skin texture, or the like). To do so, the identity feature vectors may be obtained by using algorithms to analyze the input, identify key features, and translate these into numerical vectors.

Each identity feature vector of the plurality of identity feature vectors may be associated with an identity attribute of a plurality of identity attributes. For example, in an implementation where iris data, voice data, and facial data are collected from the media data, a first identity feature vector may represent iris data, while a second identity feature vector may represent voice data, and a third identity feature vector may represent facial data. In addition, each identity attribute may be represented by a single identity feature vector for a given time period of a predetermined time interval, while an identity feature vector is generated for that identity attribute at each of the predetermined time intervals.

The identity feature vector extraction process may include the system 130 preprocessing the media data to enhance quality and reduce noise. Subsequently, the system 130 may use edge detection, segmentation, and pattern recognition to identify and isolate important features. These features may then be encoded into vectors using predefined models and algorithms. The types of algorithms used to extract identity feature vectors may include, but are not limited to, one or more of convolutional neural networks (CNNs), Mel-frequency cepstral coefficients (MFCCs), recurrent neural networks (RNNs), principal component analysis (PCA), and scale-invariant feature transform (SIFT).

The foregoing (as well as subsequent steps herein) may occur at a predetermined time interval over a duration of the interaction. For example, in some implementations, an identity feature vector may be extracted every second, 5 seconds, 10 seconds, 30 seconds, 1 minute, 2 minutes, or any suitable time interval throughout the course of an interaction. In some implementations, identity feature vectors may be averages or other calculated/weighted accumulations of feature vectors over the predetermined time interval. For example, eye movement data may be collected at multiple instances within the first 1-minute predetermined time interval, then subsequently averaged or otherwise weighted such that a single identity feature vector represents the entire 1-minute predetermined time interval.

In various implementations, an identity feature vector may be a feature vector, an identity attribute vector, or both. When the identity feature vector functions as a feature vector, it may include a set of numerical values that represent various attributes or characteristics of an object, which can include, but are not limited to, pixel intensities in an image, spectral features in audio signals, or textual feature counts. Conversely, when the identity feature vector is an identity attribute vector, it may include fingerprint ridges, facial geometry, iris patterns, or voice modulation characteristics. Notably, the identity feature vector may also be both, wherein it integrates general features with identity attribute-specific data.

At block 406, the system 130 may determine a vector similarity score for each identity feature vector. To do this, the system 130 may implement a comparison action using a trained machine learning model 324. The machine learning model 324 receives each identity feature vector of the plurality of identity feature vectors, compares the identity feature vector to a stored identity feature vector corresponding to the same identity attribute, and outputs a similarity score. In some implementations, the similarity score may be a Euclidean distance between the identity feature vector and the corresponding stored identity feature vector. Additionally, or alternatively, the similarity score may be a Cosine similarity between the identity feature vector and the corresponding stored identity feature vector. Additionally, or alternatively, the similarity score may be a Manhattan distance between the identity feature vector and the corresponding stored identity feature vector. Additionally, or alternatively, the similarity score may be a dot product between the identity feature vector and the corresponding stored identity feature vector.

Although described extensively with respect to FIG. 3, an overview of the training of the machine learning model 324 is provided henceforth. The model 324 may receive a training interaction comprising training media data. The training media data may be labeled to form labeled training media data. The machine learning model may then be trained using the labeled training media data to form the trained machine learning model 324. The trained machine learning model 324 may then undergo hyperparameter tuning to achieve the desired output.

Turning now to FIG. 5A, which is a tabular depiction of the identity feature vectors, the columns labeled as vector similarity scores 508 are illustrated. As shown in FIG. 5A, for a given feature (e.g., “feature_1”, “feature 2”, etc.), the vector similarity score 508 is associated with an identity attribute 504. Each identity attribute 504 is repeated for a given time interval 502, such that each time interval 502 includes the identity attributes 504 and their associated vector similarity scores 508.

It will be appreciated in view of FIG. 5A that each identity attribute 504 may include multiple features (e.g., “feature_1”, “feature 2”, etc.). These features may be representative of specific aspects or characteristics of a given identity attribute 504, for example a right eye, a left eye, an iris position, etc., each feature of which may fall within the same identity attribute 504. Although FIG. 5A depicts 5 features per identity attribute 504, implementations are contemplated that include more than 5 features, or less than 5 features.

Returning now to FIG. 4, next, at block 408, the system 130 may determine, for each identity attribute for the predetermined time intervals, a confidence score for each vector similarity score having a value above a first predetermined threshold. Indeed, vector similarity scores that fall outside a predetermined range may be indicative of bad data, malfunction of the machine learning model 324, lack of availability of identity feature vectors for a specific identity attribute, and so forth. Thus, in some implementations, a confidence score of “0” may be assigned to identity attributes of a given time interval to indicate that the data (e.g., the vector similarity score(s)) are not conducive to further use.

In some implementations, the system 130 may also determine a training flag value for further training of the trained machine learning model 324. To do so, and as shown in FIG. 5A by training flag column 506, a training flag may be applied as a “1” when a corresponding confidence score 510 is available, as determined in block 408. In other words, when there is a non-zero value as a confidence score (by comparing each confidence score to a predetermined confidence score threshold of “0” in this instance), the system 130 indicates a training flag by use of the numeral “1” or other value/label. In the event that a training flag is applied (e.g., a value of “1”), the newly received identity feature vectors may be included in the trained machine learning model 324 by means of training on such identity feature vectors.

At block 410 of FIG. 4, the system 130 may determine a trust score for each vector similarity score having a confidence score. To illustrate this, it shall be appreciated that in FIG. 5A, at a time of “11:01 AM”, the “Attribute A” identity attribute 508 has a confidence score 510 of “49”, thus a trust score shall be determined in block 410. However, “Attribute C” identity attribute 508 at the same time of “11:01 AM” has a trust score of “0”, as determined in block 408, and therefore “Attribute C” identity attribute 508 at “11:01 AM” will not have a trust score determined in block 410.

Turning to FIG. 5B to illustrate, at a time of “11:01 AM”, the “Attribute A” identity attribute 508 has a trust score 518 of “0.167”, while at the same time of “11:01 AM”, the “Attribute C” identity attribute 508 has a trust score 518 of “-” (i.e., not available/not determined). Similar unavailability of trust score 518 is also shown regarding “Attribute F” for the time of “11:01 AM”. As such, six (6) identity attributes 508 have confidence scores available for 11:01 AM.

Trust scores, when available/determined, are equally weighted with other trust scores within a given time interval (with a notable exception for trust scores of “0” as will be discussed in subsequent paragraphs). In other words, trust scores may be equally weighted with trust scores having respective vector similarity scores having a confidence score above a second predetermined threshold within a respective time interval. For example, in FIG. 5B, at a time “11:01 AM”, Attributes A, B, D, E, G, and H are each provided with trust scores of “0.167”, the sum of which (i.e., 0.167 multiplied by 6) is equal to 1 (which is defined as a “cumulative score” or “cumulative trust score” as will be described in subsequent steps. Similarly, in FIG. 5B, at a time “11:04 AM”, Attributes B, C, D, E, and F are each provided with trust scores of “0.2”, the sum of which (i.e., 0.2 multiplied by 5) is also equal to 1. Although the sum of “1” was chosen for cumulative trust scores comprising identity attributes that each are available and have all non-zero trust scores, other sums are contemplated.

While trust scores 518 for some identity attributes 508 are unavailable/not determined as a result of their corresponding confidence scores being “0”, other identity attributes 508 may be determined to be “0” (instead of unavailable/not determined) if their corresponding confidence scores are below a predetermined threshold (i.e., a “second predetermined threshold”). For example, in FIG. 5B, at a time of “11:02 AM”, the “Attribute E” identity attribute 508 has a trust score 518 of “0”. This corresponds to the confidence score 510 of “Attribute E” at the time of “11:02 AM” shown in FIG. 5A of “47”, which may be below a second predetermined threshold set forth for Attribute E.

Unlike identity attributes 508 that are unavailable/not determined (marked as “-” in FIG. 5B), identity attributes with a “0” trust score are included in determining the weighting of non-zero trust scores for a given time interval 502. While these trust scores remain “0”, their presence lowers the trust scores of the remaining identity attributes having available trust scores for a given time interval 502.

For example, in FIG. 5B, at a time “11:02 AM”, trust scores for Attributes A, C, E, G, and H are available to be determined (i.e., the confidence scores if FIG. 5A corresponding to these identity attributes at 11:02 AM are each non-zero). Since this represents five (5) total trust scores for the time interval to be determined, these trust scores are determined to be “0.2”, which, when multiplied by five (5) is equal to 1. However, Attribute E at 11:02 AM will be provided a trust score of “0”, for reasons described above, but the remaining Attributes A, C, G, and H will still have trust scores determined to be “0.2”, regardless of there only being four (4) identity attributes remaining for the time interval.

To understand the impact of the foregoing, we return to FIG. 4, where the process may continue at block 412. At block 412, the system 130 may determine a cumulative trust score 512 for each respective time interval. By summing all of the trust scores for a given time interval 502, a cumulative trust score 512 of “1” (or any other predetermined value) is determined for time intervals 502 having no trust scores with value of “0” (regardless of how many unavailable/not determined trust scores are present in the time interval 502). Similarly, a cumulative trust score 512 of less than “1” (or any other predetermined value) is determined for time intervals 502 having one or more trust scores with value of “0”.

Next, at block 414, the system 130 may determine a temporal cumulative trust score 516 comprising the cumulative trust score for each time interval. In FIG. 5B, the temporal cumulative trust score 516 has been determined to be “0.96”, which was determined by calculating the average (mean) of the cumulative trust scores for 11:01 AM, 11:02 AM, 11:03 AM, 11:04 AM, and 11:05 AM. In other implementations, the temporal cumulative trust score 516 may be calculated using median values, mode, or the like.

Returning to FIG. 4, at block 416, the system 130 may then terminate the interaction upon a condition (the “second condition”) where the temporal cumulative trust score 516 is below a third predetermined threshold. For example, if the temporal cumulative trust score 516 of “0.96” in FIG. 5B was below a predetermined threshold of “0.99”, the system 130 may conclude that it is unable to discern whether synthetic media data is present based on the data gathered and foregoing analysis. Therefore, it may conclude the analysis without reaching conclusions. Any suitable value for the predetermined threshold (“third predetermined threshold”) is contemplated and may be implemented and increased or decreased to alter the accuracy of the system 130.

Additionally, or as an alternative to the determination of the temporal cumulative trust score 516 of block 414, the system 130 may determine a feature validation score 514 for each identity attribute. As used herein, a “trust score series” for an identity attribute may refer to the trust scores for the identity attribute over the duration of the interaction (i.e., for all of the time intervals 502).

The feature validation score 514 may be based on the contents of the trust score series, such that a trust score series may yield a feature validation score 514 for a given identity attribute of “0” should any of the trust scores 518 within the trust score series be “0”. A trust score series may yield a feature validation score 514 for a given identity attribute of “1” should no trust scores 518 within the trust score series be “0”. Additionally, or alternatively, a compiled feature validation score may be determined, which may be “0.875”, which was determined by calculating the average (mean) of the feature validation scores 514 for Attributes A through H. In other implementations, the compiled feature validation score may be calculated using median values, mode, or the like.

As such, and additionally, or alternatively to the second condition, the system 130 may terminate the interaction upon a different condition (the “third condition”) where either (i) the feature validation score, (ii) the compiled feature validation score, or (iii) both the feature validation score and the compiled feature validation score, is below a predetermined threshold (the “fourth predetermined threshold”).

At block 418, the system 130 may transmit a control signal to an endpoint device 140. This control signal may be sent to the endpoint device 140 upon occurrence of the second condition, the third condition, or both. The control signal may be such that it notifies, through a notification (e.g., pop-up notification, text message, email, phone call, or the like) that the media data of the interaction is likely synthetic media data. Additionally, or alternatively, the system 130 may end the interaction automatically as a result of the control signal, to prevent any further interaction with the malfeasant actor perpetuating the synthetic media data.

In the absence of the transmission of a control signal to the endpoint device 140 (i.e., the system 130 having determined that the interaction does not contain any synthetic media data), the system 130 may allow the interaction to continue uninterrupted (as is the case when collecting media data from the interaction in real-time) or the system 130 may move on to analyze another interaction comprising media data. In implementations where the interaction comprised a resource transfer (e.g., a transaction that requires authorization), the system 130 may authorize the resource transfer as a result of the control signal.

As will be appreciated by one of ordinary skill in the art, the present disclosure may be implemented as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for iterative and hierarchical quantitative diagnostics and detection of synthetic media data, the system comprising:
a processing device;
a non-transitory storage device containing instructions when executed by the processing device, causes the processing device to perform the steps of:
receiving an interaction comprising media data;
collecting, at a predetermined time interval over a duration of the interaction, a plurality of identity feature vectors from the media data, each identity feature vector of the plurality of identity feature vectors being associated with an identity attribute of a plurality of identity attributes;
determining a vector similarity score for each identity feature vector of the plurality of identity feature vectors by comparing, using a trained machine learning model, each identity feature vector of the plurality of identity feature vectors to stored identity feature vectors;
determining, for each identity attribute for the predetermined time intervals, a confidence score for each vector similarity score having a value above a first predetermined threshold;
determining a trust score for each vector similarity score having a confidence score, wherein the trust score is equally weighted with other respective vector similarity score having a confidence score above a second predetermined threshold within a respective time interval, wherein the trust score is zero upon a first condition where the confidence score is below the second predetermined threshold, and wherein the trust scores for the identity attribute over the duration of the interaction forms a trust score series associated with the identity attribute;
determining a cumulative trust score for each respective time interval;
determining a temporal cumulative trust score comprising the cumulative trust score for each respective time interval;
terminating the interaction upon a second condition where the temporal cumulative trust score is below a third predetermined threshold; and
transmitting a control signal to an endpoint device upon occurrence of the second condition.

2. The system of claim 1, wherein the instructions further cause the processing device to perform the steps of:
receiving a training interaction comprising training media data;
labeling the training media data to form labeled training media data;
training a machine learning model using the labeled training media data to form the trained machine learning model; and
hyperparameter tuning of the trained machine learning model.

3. The system of claim 2, wherein the instructions further cause the processing device to perform the steps of:
determining a training flag value for further training of the trained machine learning model by comparing each confidence score to a predetermined confidence score threshold.

4. The system of claim 1, wherein collecting the plurality of identity feature vectors from the media data occurs in real-time.

5. The system of claim 1, wherein each identity attribute of the plurality of identity attributes is selected from the group consisting of facial data, eye movement data, voice data, iris data, facial expression data, gesture data, passive liveness data, and skin texture.

6. The system of claim 1, wherein each identity feature vector of the plurality of identity feature vectors is selected from the group consisting of an identity attribute vector and a feature vector.

7. The system of claim 1, wherein the instructions further cause the processing device to perform the steps of:
determining a feature validation score for each identity attribute based on trust scores within the trust score series associated with the identity attribute; and
terminating the interaction upon a third condition where the feature validation score is below a fourth predetermined threshold.

8. A computer program product for iterative and hierarchical quantitative diagnostics and detection of synthetic media data, the computer program product comprising a non-transitory computer-readable medium comprising code causing an apparatus to:
receive an interaction comprising media data;
collect, at a predetermined time interval over a duration of the interaction, a plurality of identity feature vectors from the media data, each identity feature vector of the plurality of identity feature vectors being associated with an identity attribute of a plurality of identity attributes;
determine a vector similarity score for each identity feature vector of the plurality of identity feature vectors by comparing, using a trained machine learning model, each identity feature vector of the plurality of identity feature vectors to stored identity feature vectors;
determine, for each identity attribute for the predetermined time intervals, a confidence score for each vector similarity score having a value above a first predetermined threshold;
determine a trust score for each vector similarity score having a confidence score, wherein the trust score is equally weighted with other respective vector similarity score having a confidence score above a second predetermined threshold within a respective time interval, wherein the trust score is zero upon a first condition where the confidence score is below the second predetermined threshold, and wherein the trust scores for the identity attribute over the duration of the interaction forms a trust score series associated with the identity attribute;
determine a cumulative trust score for each respective time interval;
determine a temporal cumulative trust score comprising the cumulative trust score for each respective time interval;
terminate the interaction upon a second condition where the temporal cumulative trust score is below a third predetermined threshold; and
transmit a control signal to an endpoint device upon occurrence of the second condition.

9. The computer program product of claim 8, wherein the code further causes the apparatus to:
receive a training interaction comprising training media data;
label the training media data to form labeled training media data;
train a machine learning model using the labeled training media data to form the trained machine learning model; and
hyperparameter tune the trained machine learning model.

10. The computer program product of claim 9, wherein the code further causes the apparatus to:
determine a training flag value for further training of the trained machine learning model by comparing each confidence score to a predetermined confidence score threshold.

11. The computer program product of claim 8, wherein collecting the plurality of identity feature vectors from the media data occurs in real-time.

12. The computer program product of claim 8, wherein each identity attribute of the plurality of identity attributes is selected from the group consisting of facial data, eye movement data, voice data, iris data, facial expression data, gesture data, passive liveness data, and skin texture.

13. The computer program product of claim 8, wherein each identity feature vector of the plurality of identity feature vectors is selected from the group consisting of an identity attribute vector and a feature vector.

14. The computer program product of claim 8, wherein the code further causes the apparatus to:
determine a feature validation score for each identity attribute based on trust scores within the trust score series associated with the identity attribute; and
terminate the interaction upon a third condition where the feature validation score is below a fourth predetermined threshold.

15. A method for iterative and hierarchical quantitative diagnostics and detection of synthetic media data, the method comprising:
receiving an interaction comprising media data;
collecting, at a predetermined time interval over a duration of the interaction, a plurality of identity feature vectors from the media data, each identity feature vector of the plurality of identity feature vectors being associated with an identity attribute of a plurality of identity attributes;
determining a vector similarity score for each identity feature vector of the plurality of identity feature vectors by comparing, using a trained machine learning model, each identity feature vector of the plurality of identity feature vectors to stored identity feature vectors;
determining, for each identity attribute for the predetermined time intervals, a confidence score for each vector similarity score having a value above a first predetermined threshold;
determining a trust score for each vector similarity score having a confidence score, wherein the trust score is equally weighted with other respective vector similarity score having a confidence score above a second predetermined threshold within a respective time interval, wherein the trust score is zero upon a first condition where the confidence score is below the second predetermined threshold, and wherein the trust scores for the identity attribute over the duration of the interaction forms a trust score series associated with the identity attribute;
determining a cumulative trust score for each respective time interval;
determining a temporal cumulative trust score comprising the cumulative trust score for each respective time interval;
terminating the interaction upon a second condition where the temporal cumulative trust score is below a third predetermined threshold; and
transmitting a control signal to an endpoint device upon occurrence of the second condition.

16. The method of claim 15 further comprising:
receiving a training interaction comprising training media data;
labeling the training media data to form labeled training media data;
training a machine learning model using the labeled training media data to form the trained machine learning model; and
hyperparameter tuning of the trained machine learning model.

17. The method of claim 16, further comprising:
determining a training flag value for further training of the trained machine learning model by comparing each confidence score to a predetermined confidence score threshold.

18. The method of claim 15, wherein collecting the plurality of identity feature vectors from the media data occurs in real-time.

19. The method of claim 15, wherein each identity attribute of the plurality of identity attributes is selected from the group consisting of facial data, eye movement data, voice data, iris data, facial expression data, gesture data, passive liveness data, and skin texture.

20. The method of claim 15, further comprising:
determining a feature validation score for each identity attribute based on trust scores within the trust score series associated with the identity attribute; and
terminating the interaction upon a third condition where the feature validation score is below a fourth predetermined threshold.
